(19) United States
(12) Patent Application Publication
(10) Pub. No.: US 2026/0149555 A1
(43) Pub. Date: May 28, 2026

(54) Methods and Apparatus for Determining an Offset for Time Synchronization in a Communication Network

(71) Applicant: Telefonaktiebolaget LM Ericsson (publ), Stockholm (SE)

(72) Inventors: Gemma Vall-Llosera, Järfälla (SE); Jonas Almlöf, Sollentuna (SE); Thomas Lettner, Tumeltsham (AT); Samuel Gyger, Uppsala (SE); Val Zwiller, Stocksund (SE)

(21) Appl. No.: 19/121,657

(22) PCT Filed: Oct. 17, 2022
(86) PCT No.: PCT/SE2022/050939

§ 371 Date: Apr. 16, 2025

(51) Int. Cl. H04L 7/00; H04B 10/70

(52) U.S. Cl. CPC H04L 7/0075; H04B 10/70

(57) ABSTRACT

A method of determining an offset between a first time reference and a second time reference is disclosed. The method comprises obtaining (102) information relating to a detection time at a first node of a first photon of a first pair of photons, and a detection 5time at a second node of a second photon of the first pair of photons; obtaining (104) information relating to a detection time at the first node of a first photon of a second pair of photons, and a detection time at the first node of a third photon; and determining (106) an offset between a first time reference at the first node and a second time reference at the second node based on the obtained information. An apparatus, a computer program 0and a computer program product for determining an offset between a first time reference and a second time reference are disclosed.

### TECHNICAL FIELD

Examples of the present disclosure relate to methods of and apparatuses for determining an offset for time synchronization in a communication network.

### BACKGROUND

Telecommunication networks use highly accurate clocks in order, for example, to time stamp events, and to avoid bit slips during communication. Most of the relevant synchronization requirements for telecommunication networks are defined by the 3GPP standardization body, which are then delivered by a number of technologies: global navigation satellite system (GNSS), over-the-air-synchronization (OAS), frequency-over-transport, time/phase over transport, and clocks. The GNSS consists of a set of satellites that host an atomic clock. The signal from the atomic clock is transmitted towards the Earth and received by a GNSS receiver. In a 5G telecommunication network, the reference clock from the GNSS is used by a digital unit that distributes the clock to radio units. In turn, a radio unit can use over-the-air-sync to synchronize another radio unit. The digital unit also distributes the clock over the transport network, utilizing timing protocols such as precision time protocol (PTP). A backup system is achieved via the PTP network that is fed from geographically redundant telecommunication grand masters (T-GMs) and distributes timing over the same physically redundant topologies that are used for user traffic. The T-GMs receive, in turn, signals from the GNSS [1]. However, it is known that GNSS can be spoofed or fail. For GNSS, the origin of the signal cannot be verified beyond doubt.

Time synchronization in current communication infrastructure is required to synchronize communication time slots and timestamp transaction. For 5G, itis required to prevent interferences in time division duplex (TDD) communication. A typical target requirement is approximately 1 microsecond with respect to an absolute reference. Time synchronization is also required in 5G for combining radio signals in carrier aggregation and dual connectivity. The target requirement is 3 microseconds Relative Time Error (TAE), and for co-located antennas, even more stringent requirements apply (260-65 nanoseconds). Future communication infrastructure is expected to require tighter timing requirements in the order of a nanosecond.

Time transfer over fiber (TTOF) enables synchronization of distant clocks connected by optical fibers. Amplitude-modulated continuous-wave lasers, mode-locked lasers or frequency combs generate the synchronization signal. Two-way transfer over fiber (TWTTOF) schemes allow for compensation of propagation length fluctuations in the fiber. TWTTOF using dispersion-compensated fibers achieves lower time deviations (sub-picosecond) compared to GNSS. However, time accuracy may be an issue for TWTTOF [1].

Security is a main concern for TTOF implementations. Quantum TWTTOF offers a solution and has been demonstrated using frequency-entangled photon sources based on spontaneous parametric down-conversion (SPDC) [2]. Single photon detectors (for example, superconducting nanowire single-photon detectors (SNSPDs)) register single photons, and event timers (ET) then correlate the detection events. A Bell inequality test can ensure the security of the process by verifying the entanglement of the registered photons, thereby authenticating the source of the photons.

Photon statistics can be used to classify different states of light. If we consider the mean photon number (that is, the mean number of photons in a mode), and the probability distribution of this photon number we obtain three types of distributions: Sub-Poissonian, Poissonian and super-Poissonian. A special type of sub-Poissonian light exhibits a Dirac delta distribution, meaning that a source of this light with a mean photon number of 1 will only produce single photon states. In contrast, a source of light with a different distribution with a mean photon number of 1 will have a probability of the source emitting 0, 1, 2, 3 or more photons per emission event with likelihoods larger than 0.

Reference [2] is an example of a method of quantum time synchronization which uses a highly attenuated laser and crystal (that is, an SPCD source). For this type of source, there is a tradeoff between the efficiency of the method, and the security of the method. SPDC sources do not produce pair of Fock states, (that is, the probability distribution of the mean photon number does not follow a Dirac delta distribution), but squeezed states with remaining multi-photon probability. As a result, even if the mean photon number of the source is n=1, there is a probability that each emission event will result in 0 photons, or 1 photon or more, depending on the operating point. Higher photon rates directly lead to a worse ratio of single photon purity. That is, the SPDC emission process is non-deterministic in photon number, and thus, it is not a deterministic source and does not realize a true single photon source. This limits the distances for implementing the protocol similar to the case for QKD [6].

Previous demonstrations of quantum time synchronizations are based on SPDC sources as seen in reference [2]. However, these methods are based on non-deterministic sources (e.g. SPDC), use two sources of correlated photons, or require the use of dispersion compensating fiber in the apparatus.

### SUMMARY

One aspect of this disclosure provides a method of determining an offset between a first time reference and a second time reference. The method comprises (i) obtaining information relating to a detection time at a first node of a first photon of a first pair of photons, and a detection time at a second node of a second photon of the first pair of photons, wherein the first pair of photons have been generated at the first node; (ii) obtaining information relating to a detection time at the first node of a first photon of a second pair of photons, and a detection time at the first node of a third photon, wherein the second pair of photons have been generated at the first node, and the third photon is received from the second node in response to sending a second photon of the second pair of photons to the second node; and (iii) determining an offset between a first time reference at the first node and a second time reference at the second node based on the obtained information.

Another aspect of this disclosure provides a method performed in a first node. The method comprises (i) generating a first pair of photons; (ii) obtaining information relating to a detection time at the first node of a first photon of the first pair of photons; (iii) sending a second photon of the first pair of photons to a second node; (iv) obtaining information relating to a detection time at a second node of a second photon of the first pair of photons; (v) generating a second pair of photons; (vi) obtaining information relating to a detection time at the first node of a first photon of the second pair of photons; (vii) sending a second photon of the second pair of photons to a second node; (viii) obtaining information relating to a detection time at the first node of a third photon, wherein the third photon is received from the second node in response to sending the second photon of the second pair of photons to the second node; and (ix) determining an offset between a first time reference at the first node and a second time reference at the second node based on the obtained information.

Another aspect of this disclosure provides an apparatus for determining an offset between a first time reference and a second time reference. The apparatus is configured to (i) obtain information relating to a detection time at a first node of a first photon of a first pair of photons, and a detection time at a second node of a second photon of the first pair of photons, wherein the first pair of photons have been generated at the first node; (ii) obtain information relating to a detection time at the first node of a first photon of a second pair of photons, and a detection time at the first node of a third photon, wherein the second pair of photons have been generated at the first node, and the third photon is received from the second node in response to sending a second photon of the second pair of photons to the second node; and (iii) determine an offset between a first time reference at the first node and a second time reference at the second node based on the obtained information.

Another aspect of this disclosure provides a first node. The first node is configured to (i) generate a first pair of photons; (ii) obtain information relating to a detection time at the first node of a first photon of the first pair of photons; (iii) send a second photon of the first pair of photons to a second node; (iv) obtain information relating to a detection time at a second node of a second photon of the first pair of photons; (v) generate a second pair of photons; (vi) obtain information relating to a detection time at the first node of a first photon of the second pair of photons; (vii) send a second photon of the second pair of photons to a second node; (viii) obtain information relating to a detection time at the first node of a third photon, wherein the third photon is received from the second node in response to sending the second photon of the second pair of photons to the second node; and (ix) determine an offset between a first time reference at the first node and a second time reference at the second node based on the obtained information.

### BRIEF DESCRIPTION OF THE FIGURES

For a better understanding of examples of the present disclosure, and to show more clearly how the examples may be carried into effect, reference will now be made, by way of example only, to the following Figures in which:

FIG. 1 is a flow chart of an example of a method 100 of determining an offset between a first time reference and a second time reference;

FIG. 2 is a flow chart of an example of a method 200 of determining an offset between a first time reference and a second time reference, performed by a first node;

FIG. 3 illustrates a system 300 for determining an offset between a first time reference at a first node and a second time reference at a second node;

FIG. 4 is a schematic of an example of an apparatus 400 for determining an offset between a first time reference and a second time reference; and

FIG. 5 is a schematic of an example of a first node 500 for determining an offset between a first time reference at the first node 500 and a second time reference at a second node.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments of the present disclosure relate to methods of time synchronization. Some embodiments of the present disclosure provide quantum-measurement certified, high accuracy (that is, accurate to less than 260-265 nanoseconds) time synchronization method using cascaded single photons. That is, these methods can be secured from spoofing by an adversary.

Example methods described herein can be used in accordance with a system comprising a first node (with a first time reference), and one or more second nodes, where the one or more second nodes can then receive highly accurate (that is, accurate to less than 260-265 nanoseconds) time synchronization information from the first node. The one or more second nodes may be separated from the first node by kilometers of optical fiber.

Example methods herein use single photons from a cascaded three-level system (for example, self-assembled quantum dots). As will be explained in greater detail below, cascaded photon emission sources may outperform other photon emission sources in producing single photon states.

Furthermore, the generation time between the first photon and the second photon generated as a result of the cascade is unique (due to the stochastic nature of the quantum system generating the photons). As such, an external party will be unable to spoof the generation of the photon pair, as the generation time of the second photon is not known before the emission of the second photon.

Certain methods described herein can also be secured from spoofing by an adversary through the use of entangled photon pairs. A Bell test can then be performed to certify that each photon of the entangled photon pair was generated by the first node, and not some intermediate party.

Embodiments of the present disclosure also utilize a photon emission source at the first node, but do not require a photon emission source at the second node. As a result, systems described herein reducing the complexity and the cost of the second node.

Certain systems described herein, that are based on deterministic photon generation, can generate higher photon counts and therefore shorter acquisition times) for synchronization while maintaining purity (by virtue of the single photon source) and therefore the security of the protocol. The purity of the single photon source also allows for further transmission distances compared to SPDC sources [6].

The deterministic nature of the emission also allows certain methods herein to reuse not only the correlation between the simultaneous emitted photons (also referred to herein as a “photon pair”, or a “pair of photons), but also the correlation peaks (n to n+−1) to increase the time resolution. In contrast, SPDC sources only use the correlation between the photon pair.

Optionally, a test involving multiple measurements on photon pairs that detects that at least some of the pairs are entangled or generated at the same node, such as for example a Bell test, can also be run at a node (such as the subscriber node), with additional system complexity. In these embodiments, this provides additional security at the subscriber node that no photon was, for example, detected and reemitted with a delay by a third party. By performing a Bell Test at the subscriber node and at the source node for the reflected photons, it can be certified that no extra photons were injected into the fiber link.

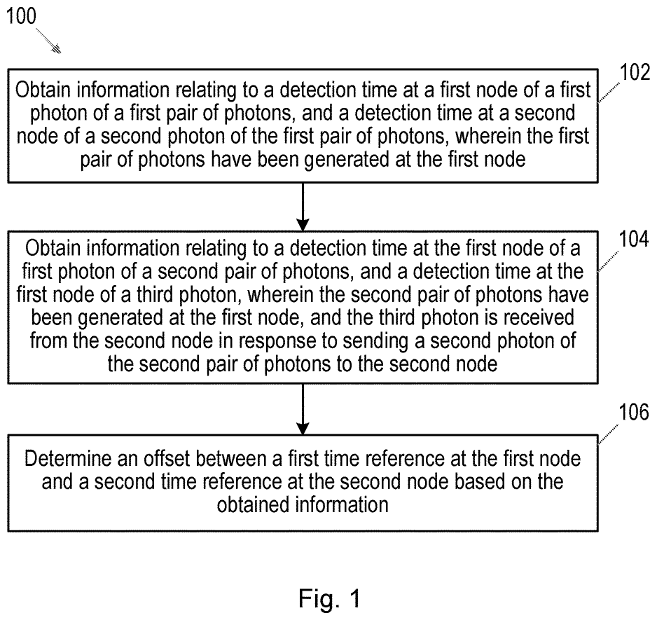

FIG. 1 is a flow chart of an example of a method 100 of determining an offset between a first time reference and a second time reference. The method 100 comprises, in step 102, obtaining information relating to a detection time at a first node of a first photon of a first pair of photons, and a detection time at a second node of a second photon of the first pair of photons, wherein the first pair of photons have been generated at the first node. In some embodiments, the first node sends the second photon of the first pair of photons to the second node. For example, the first node may send the second photon of the first pair of photons to the second node via an optical fiber.

The information relating to a detection time at a first node of a first photon of a first pair of photons may be the time at which the first photon of the first pair of photons is detected by a photodetector at the first node. For example, the information relating to a detection time at a first node may comprise a time stamp for a first time reference that is generated following the detection of the first photon by a photodetector. In some examples, the photodetector may comprise a Superconducting Nanowire Single Photon Detector.

The information relating to a detection time at a second node of a second photon of a first pair of photons may be the time at which the second photon of the second pair of photons is detected by a photodetector at the second node. For example, the information relating to a detection time at a second node may comprise a time stamp for a second time reference that is generated following the detection of the second photon by a photodetector. In some examples, the photodetector may comprise a Superconducting Nanowire Single Photon Detector.

In some embodiments, the second node may communicate information relating to a detection time at a second node of a second photon of the first pair of photons to the first node via a communication channel. The information may be communicated to the first node via deployed SMF.

In some embodiments, each pair of photons that have been generated at the first node are generated by a photon emission source. In some embodiments, the photon emission source comprises a deterministic photon source.

In some embodiments, the photon emission source comprises a source of time correlated photons. A time correlated photon source will emit pairs of photons which are time correlated. It will be appreciated that the use of time correlated photon pairs in the methods described herein prevents the methods from being easily spoofed. This time correlation cannot easily be spoofed by an external attacker unless they have access to a non-demolition measurement of one of the photons or a highly controlled single photon source to create a similar emission lifetime.

In some embodiments, the photon emission source comprises a source that emits photons by a radiative decay.

In some embodiments, the photon emission source comprises at least one quantum dot or quantum dot cascade. A quantum dot is an example of a photon emission source which is capable of generating entangled single photon pairs. In some embodiments, the quantum dot generates a photon pair as a result of a biexciton-exciton cascaded decay.

A biexciton-exciton cascaded decay will produce an entangled pair of single photon states. A biexciton-exciton cascaded decay is an example of a two-level decay, in which a first photon in a photon pair always follows a second photon in the photon pair. A photon emission source that generates photons as a result of a biexciton-exciton cascaded decay will therefore outperform other photon emission sources in producing single photon states. Furthermore, as the generation time between the first photon and the second photon is unique (due to the stochastic nature of the quantum system generating the photon), an external party will be unable to spoof the generation of the photon pair, as the generation time of the second photon is not known before the emission of the second photon. This is in contrast to a photon emission source such as a SPDC (where, when an entangled pair of single photon states are produced by the source, they are simultaneously emitted), which may give rise to a possibility for spoofing, as the time of emission of the photons is known.

It will be appreciated that, while the exact emission time of a quantum dot according to embodiments described herein will be uncertain (by virtue of the spontaneous decay in a cascade), following the emission of the two photons, the offset between the two time reference can be calculated via a two-photon correlation histogram derived from accumulated detection events, and thus provide an absolute time offset between the two time references, as will be described in greater detail below.

In some embodiments, each pair of generated photons comprises a pair of entangled photons. As will be explained in greater detail below, using entangled photon pairs improves the security of the methods described herein.

In some embodiments, each pair of entangled photons are polarization entangled. It will be appreciated that such a polarization entanglement will not be destroyed in an optical fiber, along which the photons may be sent, although in some examples there may be some polarization rotation or noise, which is described in more detail later in this description.

Step 104 of the method 100 comprises obtaining information relating to a detection time at the first node of a first photon of a second pair of photons, and a detection time at the first node of a third photon, wherein the second pair of photons have been generated at the first node, and the third photon is received from the second node in response to sending a second photon of the second pair of photons to the second node. For example, the first node may send the second photon of the second pair of photons to the second node via an optical fiber.

In some embodiments, the third photon is the second photon of the second pair of photons. For example, in some embodiments, the second photon of the second pair of photons is reflected at the second node towards the first node. The second photon of the second pair of photons may then arrive at the first node via an optical fiber.

It is noted that the methods described herein do not require that the second node comprises a photon emission source, nor does the second node require polarization optics. As a result, the complexity and the cost of the second node is reduced.

In some embodiments, wherein an entanglement test is performed at the second node, the second node may comprise the necessary polarization optics to enable this test to be performed.

The information relating to a detection time at a first node of a first photon of a second pair of photons may be the time at which the first photon of the second pair of photons is detected by a photodetector at the first node. For example, the information relating to a detection time at a first node may comprise a time stamp that is generated following the detection of the first photon by a photodetector. In some examples, the photodetector may comprise a Superconducting Nanowire Single Photon Detector.

The information relating to a detection time at a first node of a third photon may be the time at which the third photon is detected by a photodetector at the first node. For example, the information relating to a detection time at a first node may comprise a time stamp that is generated following the detection of the third photon by a photodetector. In some examples, the photodetector may comprise a Superconducting Nanowire Single Photon Detector.

Step 106 of the method 100 comprises determining an offset between a first time reference (such as a first clock) at the first node and a second time reference (such as a second clock) at the second node based on the obtained information. The first clock may be used by the first node to time stamp events (for example, photon detection events). The second clock may be used by the second node to time stamp events (for example, photon detection events).

In some embodiments, determining the offset based on the obtained information comprises determining the offset based on: a first time difference between the detection time at the first node of the first photon of the first pair of photons, and the detection time at the second node of the second photon of the first pair of photons, and a second time difference between the detection time at the first node of the first photon of the second pair of photons, and the detection time at the first node of the third photon. That is, these aforementioned detection times may be used to determine an offset between the first clock at the first node and the second clock at the second node. It will be appreciated that the offset may represent the difference between a time stamp generated by the first clock for a first detection event, and a time stamp generated by the second clock for a second detection event, where the first and second detection events occur at the same absolute time.

In some embodiments, the step of determining an offset between a first time reference at the first node and a second time reference at the second node based on the obtained information may comprise executing steps 102 and 104 multiple times, and determining an offset between a first time reference at the first node and a second time reference at the second node based on the obtained information from each execution of steps 102 and 104.

For example, following repeated executions of step 102, a cross correlation of the differences between each detection time at a first node of the first photon, and each respective detection time at a second node of the second photon, will have peaks at a value that represents both the one way trip time (of a photon) between the first node and the second node, and an offset between the first and second time references (that will be intrinsically reflected in the detection times).

For example, following repeated executions of step 104, a cross correlation of the differences between each detection time at the first node of the first photon, and each respective detection time at the first node of the third photon, will have peaks at a value that represents the round trip time between the first node and the second node. That is, this value allows the propagation time of the photon in the fiber to be calculated.

These two values may then be used to determine an absolute offset between the first and second time references as follows:

In some embodiments, the method 100 may be performed by the first node. However, it will be appreciated that the method 100 may be performed by any node (for example, the second node, or alternatively, a third node).

In some embodiments, the method 100 may further comprise providing the determined offset to the second node.

In some embodiments, the second node may then synchronize its time reference (that is, the second time reference) in accordance with the determined offset that has been provided.

In some embodiments, the method 100 further comprises performing a test as to whether each of the first pair of generated photons were generated at the first node, or a test as to whether the photons are entangled. For example, this may comprise performing a Bell test, and based on the Bell test, determining whether each of the first pair of generated photons were generated at the first node. In some embodiments, the method 100 further comprises performing a Bell test, and based on the Bell test, determining whether each of the second pair of generated photons were generated at the first node.

A Bell test enables correspondence between the first photon and the second photon of each pair of photons to be determined, where the photon pair is an entangled photon pair. In other words, the Bell test enables it to be determined whether both the first and second photon of a pair of photons are in fact an entangled pair that has been generated by the photon emission source.

That is, the Bell test can certify that the photons were generated by the provider, and not some intermediate party.

If the Bell test determines that the entanglement between the first and second photons has been degraded (or that the photons are not entangled), it can then be assumed that an adversary may have intercepted at least one of the photons. Following this, the detection times associated with these photons, or a determined offset relating to these detection times, may then be discarded.

In other words, the use of entangled photon pairs in the methods described herein will improve the security of the method.

In some embodiments, the entanglement test is performed at the first node. For example, the entanglement test may be performed on the first photon of the second pair of photons, and the third photon. This entanglement test may be used to verify that these photons are the original photons that were generated at the first node. In some embodiments, the entanglement test is performed at the second node. In some embodiments, the entanglement test may be performed on the first photon of the first pair of photons (which is detected at the first node), and the second photon of the first pair of photons (which is detected at the second node). This entanglement test may be used to verify that these photons are the original photons that were generated at the first node.

In some embodiments, both these aforementioned entanglement tests are performed, it can be verified that only photons generated at the first node have been detected at the first and second node respectively. This verification thereby limits the attack surface to asymmetric delay attacks, without additional loss, as asymmetric loss in the channel can be detected through the measured number of photons.

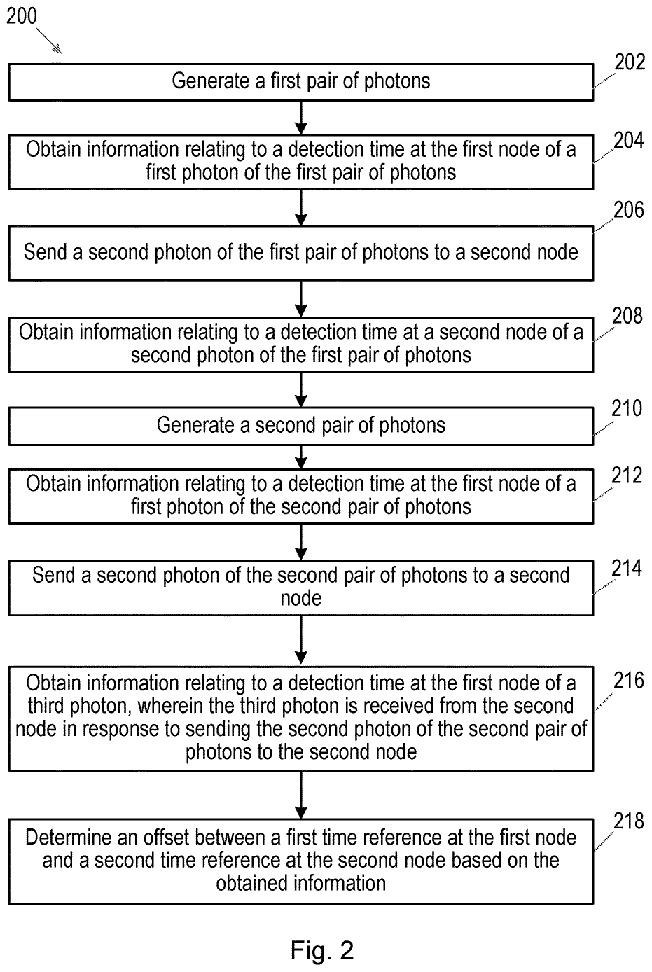

FIG. 2 is a flow chart of an example of a method 200 of determining an offset between a first time reference and a second time reference, performed by a first node. The method 200 is an example implementation of the method 100 described above.

The method 200 comprises, in step 202, generating a first pair of photons.

In some embodiments, each pair of photons generated by the first node are generated by a photon emission source. The photon emission source may correspond to any of the photon emission sources described with reference to FIG. 1. The generated photons may also feature any of the properties of the photons described with reference to FIG. 1.

Step 204 of the method 200 comprises obtaining information relating to a detection time at the first node of a first photon of the first pair of photons.

Step 206 of the method 200 comprises sending a second photon of the first pair of photons to a second node.

Step 208 of the method 200 comprises obtaining information relating to a detection time at a second node of a second photon of the first pair of photons.

Step 210 of the method 200 comprises generating a second pair of photons.

Step 212 of the method 200 comprises obtaining information relating to a detection time at the first node of a first photon of the second pair of photons.

Step 214 of the method 200 comprises sending a second photon of the second pair of photons to a second node.

Step 216 of the method 200 comprises obtaining information relating to a detection time at the first node of a third photon, wherein the third photon is received from the second node in response to sending the second photon of the second pair of photons to the second node. As described with reference to FIG. 1 in some embodiments, the third photon is the second photon of the second pair of photons. In some embodiments, the second photon of the second pair of photons has been reflected at the second node towards the first node.

Step 218 of the method 200 comprises determining an offset between a first time reference at the first node and a second time reference at the second node based on the obtained information.

In some embodiments, the method 200 further comprises performing a test to determine whether the first or second pair of generated photons were generated at the first node, or a test to determine whether the pair of photons are entangled. For example, the method 200 may comprise performing a Bell test; and based on the Bell test, determining whether each of the first pair of generated photons were generated at the first node. In some embodiments, the method 200 further comprises performing a Bell test, and based on the Bell test, determining whether each of the second pair of generated photons were generated at the first node.

In some embodiments, the step of determining the offset based on the obtained information may comprise determining the offset based on a first time difference between the detection time at the first node of the first photon of the first pair of photons, and the detection time at the second node of the second photon of the first pair of photons, and a second time difference between the detection time at the first node of the first photon of the second pair of photons, and the detection time at the first node of the third photon.

In some embodiments, the step of determining an offset between a first time reference at the first node and a second time reference at the second node based on the obtained information may comprise executing the steps 202 to 216 multiple times, and determining an offset between a first time reference at the first node and a second time reference at the second node based on the obtained information from each execution of steps 202 to 206. For example, a cross-correlation, as described above with reference to FIG. 1, may be performed by the first node to determine an offset between a first time reference at the first node and a second time reference at the second node based on the obtained information.

In some embodiments, the method 200 further comprises providing the determined offset to the second node.

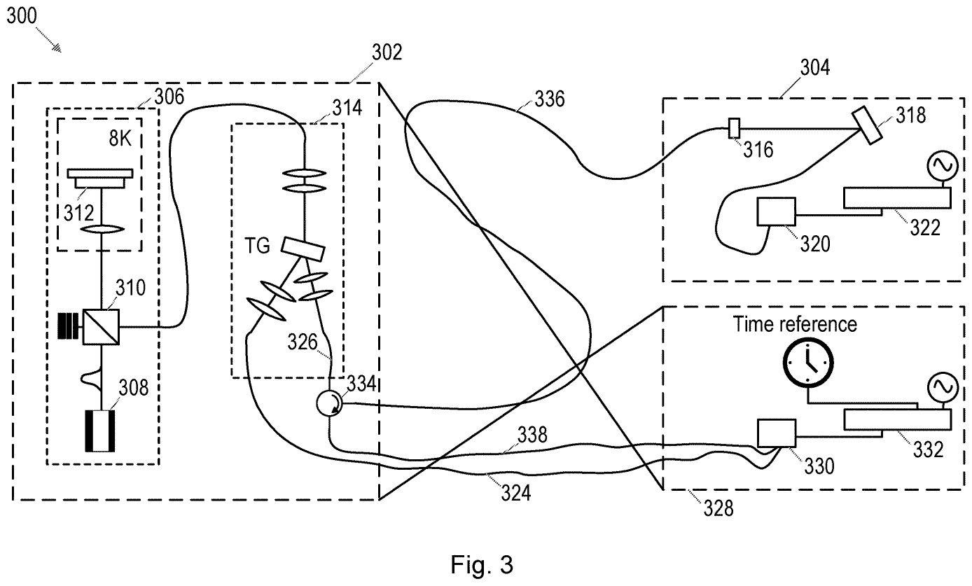

FIG. 3 illustrates a system 300 for determining an offset between a first time reference at a first node and a second time reference at a second node in accordance with the methods described herein.

The system 300 comprises a first node (or a master node) 302, and a second node (or a subscriber node) 304. In some embodiments, the first node 302 may be configured to perform either of the methods 100 or 200 described above. In some embodiments, the second node 304 may be configured to perform the method 100 described above. In this illustrated embodiment, the first node 302 determines an offset between a first time reference at the first node and a second time reference at the second node in accordance with the method 100 described above.

The first node 302 may then provide the determined offset to the second node 304. For example, the offset may be provided to the second node 304 via deployed SMF, or via an alternative communication channel.

The first node 302 comprises a photon emission source 306. The photon emission source 206 comprises a 80 MHz pulsed laser 308, a beam splitter 310, a quantum dot 312 comprised within a cryostat, and a spectral selector 314. In this illustrated embodiment, the quantum dot 312 is capable of generating deterministically, time correlated entangled single photon pairs, by virtue of a biexciton-exciton cascaded decay. In this example, the quantum dot 312 emits in the C-band.

An example of the quantum dot 312 may be found at [3] An example of a correlation diagram between a photon pair emitted by such a source may be found at [4].

It will be appreciated that, in other embodiments, alternative photon emission sources may be comprised within the first node 302. For example, the photon emission source may comprise a cascaded emission within an atomic system [7]. In another example, the photon emission source may comprise a biexciton-exciton cascade within 2D material systems.

The second node 304 comprises a reflector 316, a notch filter 318, a photodetector 320 and a time-to digital converter 322 connected to a 10 MHz reference signal.

In this illustrated embodiment, the light emitted by the pulsed laser 308 is split by the beam splitter 310, such that a percentage of the light stimulates the quantum dot 312. This stimulation then triggers a biexciton-exciton cascaded decay, which resultingly produces an entangled pair of single photon states.

The entangled pair of single photon states are then coupled back to and reflected by the beam splitter 310, such that they are then passed to the spectral selector 314.

The spectral selector 314 then only allows the entangled pair of single photon states to pass through, such that the first photon of the pair of photons is coupled into an optical fiber 324, and the second photon of the pair of photons is coupled into an optical fiber 326.

The first photon of the pair of photons is then transmitted to a master clock node 328 via the optical fiber 326. The master clock node 328 is comprised within the first node 302. The master clock node 328 comprises a photodetector 330 and a time-to digital converter 332 connected to a 10 MHz reference signal.

The second photon of the pair of photons is transmitted to a circulator 334 comprised within the first node 302, which then transmits the second photon to the second node 304 via the optical fiber 336.

The first photon of the pair of photons is then detected by the photodetector 330 at the first node 302. In this example, the photodetector 330 comprises a Superconducting Nanowire Single Photon Detector, however, it will be appreciated that alternative suitable photodetectors may be provided. The signal from the photodetector 330 is then time-stamped by the time-to-digital converter 332.

The second photon of the pair of photons arrives at the reflector 316. In this embodiment, the reflector 316 is a 70/30 fiber reflector. That is, the reflector 316 is configured to reflect 70% of the photons back to the first node 302, and to allow 30% to pass to the notch filter 318. The notch filter 318 filters out any other signals which may be present in the optical fiber network.

If the second photon is reflected by the reflector 316, it is returned to the circulator 326 at the first node 302 via the optical fiber 336, which then causes the second photon to be transmitted to the master clock node 328 via an optical fiber 338.

The second photon of the pair of photons is then detected by the photodetector 330 at the first node 302, and the detection time is time-stamped by the time-to-digital converter 332.

If the second photon is passed to the notch filter 318, the notch filter 318 then passes the second photon to the photodetector 320, and the detection time is time-stamped by the time-to-digital converter 322.

That is, for each pair of generated photons, either both the first and second photon of the photon pair will be detected at the first node 302, or the first photon of the photon pair will be detected at the first node 302, and the second photon of the photon pair will be detected at the second node 304.

The second node 304 may communicate information relating to a detection time at a second node 304 of the second photon of a pair of photons to the first node 302 via a communication channel. For example, the information may be communicated to the first node 302 via classical communication networks.

That is, information relating to a detection time at a first node 302 of a first photon of a first pair of photons, and a detection time at a second node 304 of a second photon of the first pair of photons, is obtained, wherein the first pair of photons have been generated at the first node 302, and information relating to a detection time at the first node 302 of a first photon of a second pair of photons, and a detection time at the first node 302 of a third photon, is obtained, wherein the second pair of photons have been generated at the first node 302, and the third photon is received from the second node 304 in response to sending a second photon of the second pair of photons to the second node 304. In this illustrated embodiment, this information is obtained by the first node 302. However, as noted above, the information relating to the aforementioned detection times be obtained by the second node 304, or by a third node.

As noted above, the aforementioned information relating to detection times may be obtained for multiple pairs of photons (that is, information may be obtained relating to multiple instances of a first photon of a pair of photons being detected at the first node 302, and a second photon of the pair of photons being detected at the second node 304, and information may be obtained relating to multiple instances of a first photon of a pair of photons being detected at the first node 302, and a third photon being detected at the first node 302).

A cross correlation of the differences between each detection time at a first node 302 of the first photon, and each respective detection time at a second node 304 of the second photon, and a cross correlation of the differences between each detection time at the first node 302 of a first photon, and the each respective detection time at the first node 302 of the third photon, may then be used to determine an absolute offset between the first time reference at the first node 302, and a second time reference at the second node 304 (as described above with reference to step 106). It will be appreciated that the accuracy of the method being executed with reference to the system 300 will be limited by the accuracy of the 10 MHz frequency references.

That is, an offset between a first time reference at the first node 302 and a second time reference at the second node 304 is determined based on the obtained information. In this example, this step is performed by the first node 302. However, as noted above, the second node 304 may instead perform this step, or a third node, should the information relating to the aforementioned detection times be obtained by these nodes respectively.

The determined offset may then be provided to the second node 304 by the first node 302. This determined offset may then be used by the second node 304 to synchronize the second time reference.

As described with reference to the method 100, the method being executed with reference to the system 300 is protected by the time correlation between the first and second photons of each photon pair. As each generated pair of photons are entangled, a test (such as a Bell test for example) can be performed to verify that there is entanglement between the first and second photon of each pair, and thus certify the origin of the emitted photons and make any photon measurement based attacks ineffective.

The test would therefore indicate whether an attacker has attempted to interfere with a photon (as the test would determine that entanglement of the entangled photon pair has been degraded), or if the photon has been added by the attacker themselves (as the test would confirm the origin of the added photon is not the first node 302).

As a result, using entangled photon pairs may improve the security of the method.

An example of how an adversary may attempt to introduce a delay into the system 300 is now described. An adversary may attempt to introduce some delay into the system, by reflecting some of the photons back to the first node 302, while forwarding the remaining photons to the second node 304. Although the photodetector at the first node would be unable to tell that the photons had been reflected by an adversary, as the photons are generated deterministically at the first node 302, the photons which are reflected by the second node 304 can be counted, as well as the loss of the line (which is half of the loss experienced in the line due to the photons traversing the line twice in opposite directions). As a result, the second node 304 can be informed how many photons should be expected to arrive at the second node 304.

If less than the expected number of photons arrive at the second node 304, it can be determined that there may be an attacker in the loop. Following this, previously obtained detection times, or previously determined offsets relating to these detection times, may be discarded.

As noted above, each pair of entangled photons may be polarization entangled. It will be appreciated that the polarization entanglement of a pair of entangled photons will not be destroyed in an optical fiber (by which the photons may be transmitted to the first and second node), allowing a test to be performed to certify the origin of the emitted photons. It will be appreciated that, in embodiments in which the count rate (for photon pairs that are detected) and the rate of polarization change in a fiber are of suitable values, fiber polarization drift does not have to be corrected for in order to perform the test.

It will be appreciated that the main cause of decorrelation in an optical fiber is photon absorption and dissipation. However, in order to negate these effects, only coincidences (that is, instances where both the photons of a pair of photons are detected) are considered for the entanglement tests described herein.

It is noted that polarization drift in deployed fibers may be slow. In reference [5], the fiber tested averaged a polarization change of 0.759%±0.409% per hour, which can be corrected prior to the execution of the entanglement test. Reference [5] also describes a gradient descent algorithm for polarization stabilization.

Considering now chromatic dispersion, for a 1 Gbit/s dispersion rate in a fiber, a photon can typically travel 55-60 km in the fiber before the chromatic dispersion needs to be compensated for. For a 10 Gbit/s dispersion rate, the distance is approximately 40 km. For a 40 Gbit/s dispersion rate, the distance is approximately 5 km.

For the system 300 illustrated in FIG. 3, the dispersion experienced by a pulse with 5 GHz bandwidth can be estimated as 20 ps/(nm km)*0.04 nm*100 km=80 ps for a one way transmission. It is also noted that, chromatic dispersion can be corrected with mechanisms such as FBG-based modules, with post or pre distributed compensation, with DSPs and/or with multicore fibers with a specific refractive index profile.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

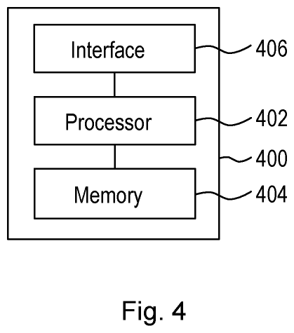

FIG. 4 is a schematic of an example of an apparatus 400 for determining an offset between a first time reference and a second time reference. The apparatus 400 comprises processing circuitry 402 (e.g. one or more processors) and a memory 404 in communication with the processing circuitry 402. The memory 404 contains instructions executable by the processing circuitry 402. The apparatus 400 also comprises an interface 406 in communication with the processing circuitry 402. Although the interface 406, processing circuitry 402 and memory 404 are shown connected in series, these may alternatively be interconnected in any other way, for example via a bus.

In one embodiment, the memory 404 contains instructions executable by the processing circuitry 402 such that the apparatus 400 is operable to obtain information relating to a detection time at a first node of a first photon of a first pair of photons, and a detection time at a second node of a second photon of the first pair of photons, wherein the first pair of photons have been generated at the first node; obtain information relating to a detection time at the first node of a first photon of a second pair of photons, and a detection time at the first node of a third photon, wherein the second pair of photons have been generated at the first node, and the third photon is received from the second node in response to sending a second photon of the second pair of photons to the second node; and determine an offset between a first time reference at the first node and a second time reference at the second node based on the obtained information.

In some examples, the apparatus 400 is operable to carry out the methods 100 and 200 described above with reference to FIGS. 1 and 2.

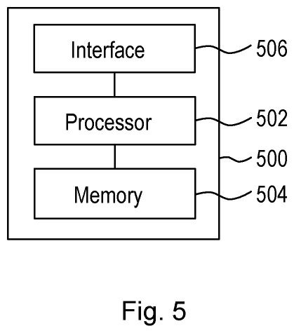

FIG. 5 is a schematic of an example of a first node 500 for determining an offset between a first time reference at the first node 500 and a second time reference at a second node. The first node 500 comprises processing circuitry 502 (e.g. one or more processors) and a memory 504 in communication with the processing circuitry 502. The memory 504 contains instructions executable by the processing circuitry 502. The first node 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the first node 500 is operable to generate a first pair of photons; obtain information relating to a detection time at the first node of a first photon of the first pair of photons; send a second photon of the first pair of photons to a second node; obtain information relating to a detection time at a second node of a second photon of the first pair of photons; generate a second pair of photons; obtain information relating to a detection time at the first node of a first photon of the second pair of photons; send a second photon of the second pair of photons to a second node; obtain information relating to a detection time at the first node of a third photon, wherein the third photon is received from the second node in response to sending the second photon of the second pair of photons to the second node; and determine an offset between a first time reference at the first node and a second time reference at the second node based on the obtained information.

In some examples, the first node 500 is operable to carry out the method 200 described above with reference to FIG. 2.

Abbreviations

| | |
|---|---|
| GNSS | global navigation satellite system |
| OAS | over the air synchronization |
| PTP | precision time protocol |
| T-GM | telecom grand master |
| TDD | time division duplex |
| TAE | relative time error |
| TTOF | time transfer over fiber |
| TWTTOF | two-way transfer over fiber |
| SPDC | spontaneous parametric down-conversion |
| SSSPD | superconductive nanowire single-photon detector |
| QD | quantum dot |
| KTH | Kungliga Tekniska Högskolan |
| BS | beam splitter |
| NF | notch filter |
| TG | transmission grating |
| T | transmission |
| R | reflectivity |

### REFERENCES

1. Stefano Ruffini et al, 5G synchronization requirements and solutions, Ericsson Technology review, #01, 2021
2. F. Hou et al., Fiber-optic two-way quantum time transfer with frequency-entangled pulses, Phys. Rev. A 100, 023849
3. Müller, M., Bounouar, S., Jöns, K. et al. On-demand generation of indistinguishable polarization-entangled photon pairs. Nature Photon 8, 224-228 (2014). https://doi.org/10.1038/nphoton.2013.377
4. Zeuner, Katharina D., et al. “A stable wavelength-tunable triggered source of single photons and cascaded photon pairs at the telecom C-band.” Applied Physics Letters 112.17 (2018): 173102.
5. Ekemar, L. (2020). Polarization stabilization for quantum key distribution in deployed fibre (Dissertation). Retrieved from http://urn.kb.se/resolve?urn=urn:nbn:se:kth:diva-279632
6. Bozzio, M., Vyvlecka, M., Cosacchi, M. et al. Enhancing quantum cryptography with quantum dot single-photon sources. npj Quantum Inf 8, 104 (2022). https://doi.org/10.1038/s41534-022-00626-z
7. Aspect, Alain, Philippe Grangier, and Gérard Roger. “Experimental tests of realistic local theories via Bell's theorem.” Physical review letters 47.7 (1981): 460.

1-43. (canceled)

44. A method of determining an offset between a first time reference and a second time reference in a communication network, the method comprising:
obtaining information relating to the following:
a first detection time, at a first node, of a first photon of a first pair of photons generated at the first node, and
a second detection time, at a second node, of a second photon of the first pair of photons;
obtaining information relating to the following:
a third detection time, at the first node, of a first photon of a second pair of photons generated at the first node, and
a fourth detection time, at the first node, of a third photon received from the second node in response to sending a second photon of the second pair of photons to the second node; and
determining an offset between a first time reference at the first node and a second time reference at the second node based on the obtained information relating to the first, second, third, and fourth detection times.

45. The method according to claim 44, wherein each pair of the first and second pairs of photons is generated by a photon emission source, which is a deterministic photon source.

46. The method according to claim 45, wherein the photon emission source comprises a source that emits photons by radiative decay.

47. The method according to claim 45, wherein the photon emission source comprises at least one quantum dot or quantum dot cascade.

48. The method according to claim 44, wherein each pair of the first and second pairs of photons comprises a pair of entangled photons.

49. The method according to claim 48, wherein each pair of the first and second pairs of photons is polarization entangled.

50. The method according to claim 48, further comprising determining whether each of the first and second photons, of the first pair, was generated at the first node and/or is entangled.

51. The method according to claim 48, further comprising determining whether each of the first and second photons, of the second pair, was generated at the first node and/or is entangled.

52. The method according to claim 44, wherein the offset is determined based on the following:
a first time difference between the first detection time and the second detection time; and
a second time difference between the third detection time and the fourth detection time.

53. The method according to claim 44, further comprising providing the determined offset to the second node.

54. A method performed in a first node configured for operation in a communication network, the method comprising:
generating a first pair of photons;
obtaining information relating to a first detection time, at the first node, of a first photon of the first pair of photons;
sending a second photon of the first pair of photons to a second node;
obtaining information relating to a second detection time, at the second node, of the second photon of the first pair of photons;
generating a second pair of photons;
obtaining information relating to a third detection time, at the first node, of a first photon of the second pair of photons;
sending a second photon of the second pair of photons to a second node;
obtaining information relating to a fourth detection time, at the first node, of a third photon received from the second node in response to sending the second photon of the second pair of photons; and
determining an offset between a first time reference at the first node and a second time reference at the second node based on the obtained information relating to the first, second, third, and fourth detection times.

55. The method according to claim 54, wherein each pair of the first and second pairs of photons is generated by a photon emission source, which is a deterministic photon source.

56. The method according to claim 55, wherein the photon emission source comprises a source that emits photons by radiative decay.

57. The method according to claim 55, wherein the photon emission source comprises at least one quantum dot or quantum dot cascade.

58. The method according to claim 54, wherein each pair of the first and second pairs of photons comprises a pair of entangled photons.

59. The method according to claim 58, wherein each pair of the first and second pairs of photons is polarization entangled.

60. The method according to claim 58, further comprising determining whether each of the first and second photons, of the first pair, was generated at the first node and/or is entangled.

61. The method according to claim 58, further comprising determining whether each of the first and second photons, of the second pair, was generated at the first node and/or is entangled.

62. An apparatus configured to determine an offset between a first time reference and a second time reference in a communication network, the apparatus comprising:
processing circuitry; and
memory operably coupled to the processing circuitry and storing executable instructions that, when executed by the processing circuitry, cause the apparatus to:
obtain information relating to the following:
a first detection time, at a first node, of a first photon of a first pair of photons generated at the first node, and
a second detection time, at a second node, of a second photon of the first pair of photons;
obtain information relating to the following:
a third detection time, at the first node, of a first photon of a second pair of photons generated at the first node, and
a fourth detection time, at the first node, of a third photon received from the second node in response to sending a second photon of the second pair of photons to the second node; and
determine an offset between a first time reference at the first node and a second time reference at the second node based on the obtained information relating to the first, second, third, and fourth detection times.

63. A first node configured for operation in a communication network, the first node comprising:
processing circuitry; and
memory operably coupled to the processing circuitry and storing executable instructions that, when executed by the processing circuitry, cause the first node to:
generate a first pair of photons;
obtain information relating to a first detection time, at the first node, of a first photon of the first pair of photons;
send a second photon of the first pair of photons to a second node;
obtain information relating to a second detection time, at the second node, of the second photon of the first pair of photons;
generate a second pair of photons;
obtain information relating to a third detection time, at the first node, of a first photon of the second pair of photons;
send a second photon of the second pair of photons to a second node;
obtain information relating to a fourth detection time, at the first node, of a third photon received from the second node in response to sending the second photon of the second pair of photons; and
determine an offset between a first time reference at the first node and a second time reference at the second node based on the obtained information relating to the first, second, third, and fourth detection times.
